(19) United States
(12) Patent Application Publication
(10) Pub. No.: US 2002/0188495 A1
(43) Pub. Date: Dec. 12, 2002

(54) Food processing management system

(75) Inventors: Dwip N. Banerjee, Austin, TX (US); Rabindranath Dutta, Austin, TX (US); Lorin Evan Ullmann, Austin, TX (US)

Correspondence Address: Robert V. Wilder, Attorney at Law, 4235 Kingsburg Drive, Round Rock, TX, 78681, US

(73) Assignee: International Business Machines Corporation, Armonk, NY

(21) Appl. No.: 09/876,046

(22) Filed: Jun. 7, 2001

(51) Int. Cl. G06F 17/60

(52) U.S. Cl. 705/10; 705/7

(57) ABSTRACT

A method and implementing system are provided in which information regarding the preparation and sale of food products and the ingredients and supplies used in the processing of such products, is recorded and used to improve the efficiency with which the food processing business is operated. In an exemplary embodiment, a database is maintained at a restaurant server for tracking food product sales, ingredients inventories, and historical demand requirements for the food products. All of the information is processed and correlated to provide information concerning food preparation and ingredient ordering schedules, as well as measuring and limiting measured food waste which results from normal operations of the food processing business.

### FIELD OF THE INVENTION

The present invention relates generally to information processing systems and more particularly to a methodology and implementation for processing information related to the food preparation industry.

### BACKGROUND OF THE INVENTION

The so-called “fast food industry” must manage the “used” inventory of food that had been pre-cooked for customers and stored in warming bins. The timing of predicting when to cook more food for the warming bin queue and when to discard food that has been in the warming bin for a period of time is a largely manual process today. The counting of waste, i.e. food cooked but not sold, is also a problem since sensors which could determine food entering a waste bin are not integrated with the used food inventory control bin.

Thus there is a need for an improved methodology and implementing system for efficiently handling food processing operations in the food preparation business.

### SUMMARY OF THE INVENTION

A method and implementing system are provided in which information regarding the preparation and sale of food products and the ingredients and supplies used in the processing of such products, is measured and recorded, and that information is used to improve the efficiency with which the food processing business is operated. In an exemplary embodiment, a database is maintained at a restaurant server for tracking food product sales, ingredients inventories, waste and historical demand requirements for the food products. All of the information is processed and correlated to provide information concerning food preparation and ingredient ordering schedules, as well as measuring and limiting measured food waste which results from normal operations of the food processing business.

### BRIEF DESCRIPTION OF THE DRAWINGS

A better understanding of the present invention can be obtained when the following detailed description of a preferred embodiment is considered in conjunction with the following drawings, in which:

FIG. 1 is an illustration of an exemplary embodiment of an interconnected server system which may be used in an implementation of the present invention;

FIG. 2 is an exemplary block diagram of several of the major components of a computer system which may be used in the exemplary implementation of the present invention;

FIG. 3 is a specific example of a food bin level detection system which may be used in food ingredient inventory control;

FIG. 4 is an example of a sensing system which may be used in detecting the number of food products that are being sold;

FIG. 5 is an exemplary flow chart illustrating food order processing in accordance with the present invention;

FIG. 6 is a flow chart illustrating an exemplary methodology which may be implemented in practicing waste management and database demand aspects of the present invention; and

FIG. 7 is a flow chart used to illustrate an automatic ordering aspect of the present invention.

### DETAILED DESCRIPTION

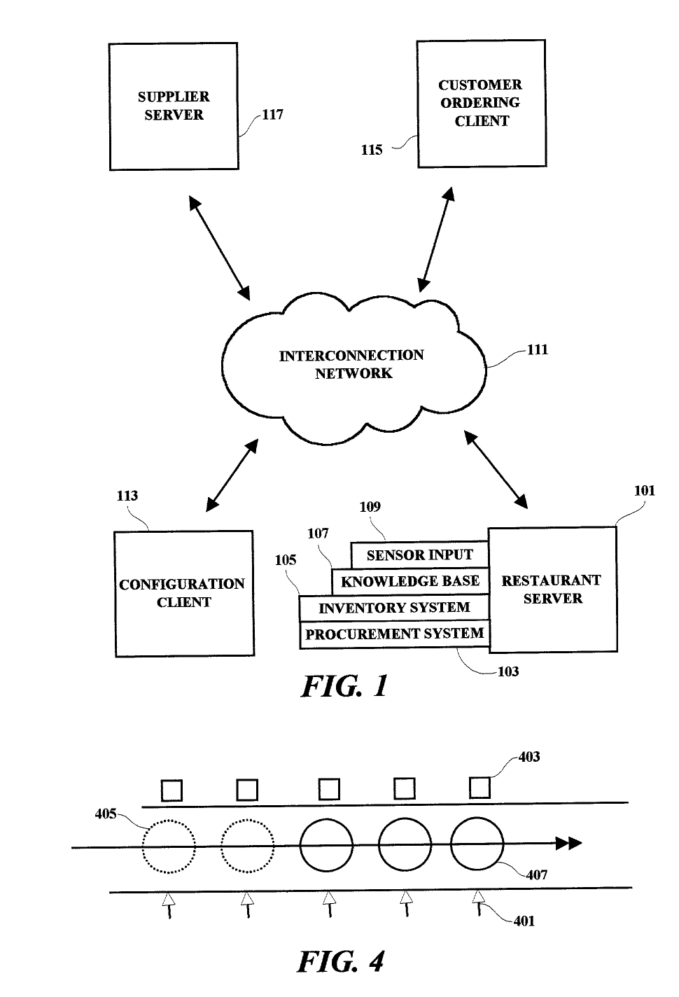

The various methods discussed herein may be implemented within a typical computer-related system which may include one or more computer systems being operated as servers on an interconnection network. The disclosed methodology may also be implemented using wireless technology including, inter alia, cell phones and Personal Digital Assistant (PDA) devices, to perform any or all of the functions described. In the example illustrated in FIG. 1, a restaurant server 101 is selectively connected through an interconnection network 111, such as the Internet, to a supply server 117, a customer ordering client 115 and a configuration client 113. The supplier server 117 is arranged to receive orders from the restaurant server 101 for supplies or ingredients used by the restaurant in preparing and selling food products. Typically, more than one supplier has contracted with the restaurant to provide supplies and each one may be contacted through the interconnection network 111 by the restaurant server, but only one supplier is illustrated in the drawing for simplicity. Also illustrated is a configuration client server 113 which is used to control various system levels such as reordering levels, i.e. the level of inventory of ingredients below which a reorder of a batch of ingredient is automatically accomplished. In the present invention, reordering of ingredients may be automatically accomplished through the use of a pre-approved electronic device such as an email or other electronically generated reorder form. A customer ordering server 115 is used to take and track customer orders for food products. The restaurant server 101 includes a procurement system 103, an inventory system 105, and a knowledge database 107. The restaurant server 101 is also arranged to receive sensor inputs 109 from food or ingredient bin sensors.

As hereinbefore noted, the restaurant server selectively connects to a plurality of other servers through an interconnection network such as the Internet, in conducting its business. In general, an implementing computer system may include a plurality of processors in a multi-bus system in a network of similar systems. However, since the workstation or computer system used in practicing the present invention in an exemplary embodiment, is generally known in the art and composed of electronic components and circuits which are also generally known to those skilled in the art, circuit details beyond those shown are not specified to any greater extent than that considered necessary as illustrated, for the understanding and appreciation of the underlying concepts of the present invention and in order not to obfuscate or distract from the teachings of the present invention.

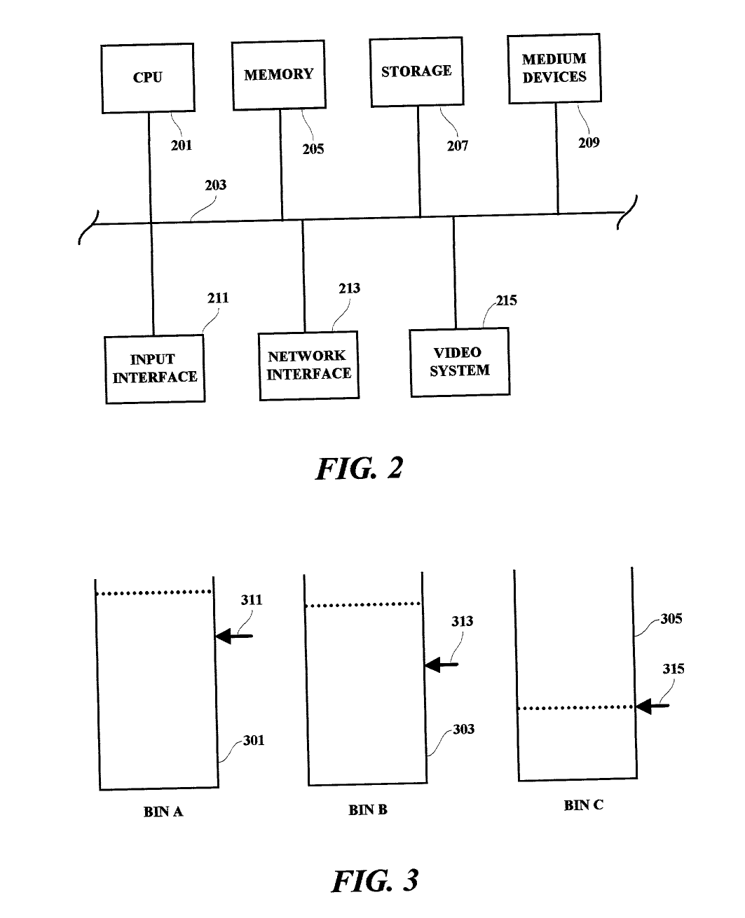

In FIG. 2, there is illustrated a block diagram of the exemplary computer system 101 which may be used as the restaurant server 101 in the present example. As shown in the FIG. 2 example, a central processing unit (CPU) 201 is connected to a system bus 203. The system bus is also connected to a memory device 205, a storage system 207, and medium devices 209 such as diskette and/or CD drives. Also shown is an input interface 211 to enable a user to input commands and menu selections. The input interface 211 may be connected to a keyboard and/or a mouse or other pointing device as is well known. The system bus is also selectively coupled to a network interface 213 which may be used to connect the restaurant server 101 to the interconnection network 111. The exemplary block diagram of FIG. 2 also includes a video system 215 which is used to display the various screen displays, menus and selection options to the operator or administrator of the restaurant server 101.

As shown in FIG. 3, the exemplary restaurant business includes a plurality of bins 301, 303 and 305, which are used to store ingredients used for the preparation of food products being sold by the restaurant. The amount of material in each of the bins may be detected in a number of ways, including light sensors and/or weight sensors. As shown, various light sensors 311, 313 and 315 are implemented in the example to determine when a particular ingredient needs to be reordered from a supplier. As is hereinafter discussed, the reordering level may be dynamically adjusted to reflect the knowledge stored in a historical demand database. For example, an ice cream store may have a higher demand for its products during the summer months than it is during the winter months. Thus the reorder levels will be adjusted upwardly for the summer months, in accordance with the methodology herein disclosed, in anticipation of a greater periodic demand which is determined through accessing the knowledge database 107. This demand curve is stored in a demand database and accessed on a pro-active basis to determine any periodic demand for products which may occur. The demand database also includes a “Remarks” field in which a proprietor may input reasons for any increased demand in the past. For example, by accessing the demand database a proprietor may determine that the next day (by calendar or day-of-month determination) may have a high demand since there was a high demand for a particular product last year on the same day. By accessing the “Remarks” field, the proprietor will be able to see that there was a critical high school football game on that day a year earlier. If the proprietor knows that there is no such game this year or the game is being played at another location, the proprietor can choose to ignore the demand database output and instead decide not to increase the number of products scheduled to be made for the next day. In another example, the demand for cold drinks from a fast food restaurant will be greater during the summer months and the safety level for “on-hand” ingredients for cold drinks is also adjusted upwardly during those time periods. In another example, information is also stored in the knowledge database 107 concerning expected business for different days of the week. For example, in some businesses, the weekends are much busier than weekdays and through accessing the database 107, sufficient food products may be prepared ahead of time and “ready” at certain times of the day even though orders have not been placed for such food products. The number of food products that have been prepared and are “ready” or on standby for immediate sale, is kept track of through various other sensing devices which also provide input to the restaurant server 101.

As illustrated in FIG. 4, food products that are prepared ahead of order and are ready for sale, are also monitored to insure sufficient product is ready for immediate sale and also that the ingredients inventory for the products being prepared is maintained at a required level. As shown in FIG. 4, prepared food products are tracked through a series of light sensors such as light sensor 401 and a series of corresponding light detectors such as detector 403. Prepared food products such as food product 407 are placed on product carriers or containers such as carrier 405, and the sensors 401,403 can determine how many food products are available at any given time. The carriers 405 may also be warming trays to keep the food product warm until it is purchased. The information concerning the number of ready food products is also passed to the restaurant server 101 for processing. Further, by tracking each food product on a ready line, it is determined how long a particular food product has been prepared but unsold. This information is used in determining and controlling the amount of food or ingredient waste, i.e. the amount of food or ingredient that has to be thrown away because it has not been sold within a predetermined period of time after the product was prepared.

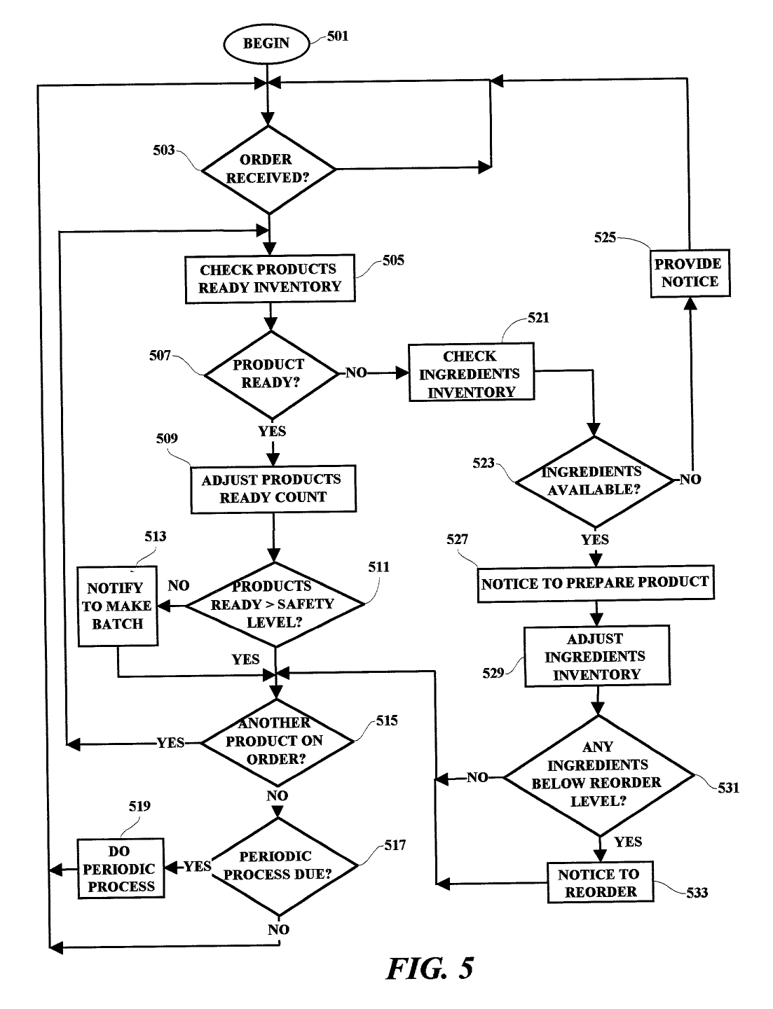

An exemplary information processing methodology which may be used in the exemplary restaurant enterprise is illustrated in FIG. 5. As shown, when the process begins 501, and it is determined that an order has been received 503, a “products ready” inventory (as determined from the products ready sensor 401,403 and maintained from inputs to the restaurant server 101) is checked 505. If there is a ready product that matches the order received 507, then the order for that particular product may be fulfilled from the available ready products on warming trays. Next the “products ready” count is adjusted 509 and a check is made to determine if the number of remaining products that are ready for immediate sale is greater than a predetermined safety level number 511. If the number of remaining ready products is greater than the safety level 511 then a check is made of the order to determine if there are additional products on the order 515 and if so, the process returns to check the products ready inventory 505 and the processing is repeated for each additional product. If the number of ready products is less than the safety level 511, then notice is provided to make more of the product 513 before checking for the next product on the order 515. When there are no more products on the order being processed 515, then a check is made to determine if it is time for one or more periodic processes that may be provided as hereinafter discussed. If there are periodic processes that need to be run 517 then those processes are run prior to returning to check for the next order 503. If there are no periodic processes to be run then the methodology returns directly to check for the next order received.

In the methodology illustrated in FIG. 5, if there are no ready products available to fill an order for a particular product 507, then the ingredients inventory, which is maintained in a server inventory database, is checked 521 to determine if the ingredients needed for the ordered product are available 523. If the ingredients are not available 523, then notice is provided 525 in a designated predetermined manner. The notice may be a flashing screen visible to a designated restaurant employee that the item is not available and that ingredients need to be ordered from suppliers. The notice may also be a return of a flag to the server in response to which the server may cause an appropriate notice to be displayed to an ordering customer. In addition, the order for a predetermined batch of the missing ingredient may be automatically placed using an automatic electronic device such as email. If the check at step 523 indicates that the ingredients are available, then notice is given to prepare the ordered product 527 and the ingredients inventory is adjusted 529 to reflect the correct current inventory for the ingredients after the amounts are withdrawn for the preparation of the ordered product. Another ingredients check may be made at this time to determine if the new ingredients level is below a reorder level 531, and if so, a notice is provided to reorder or the reordering is accomplished automatically through electronic email or other communication means. The processing then returns to check for additional products on the customer order 515.

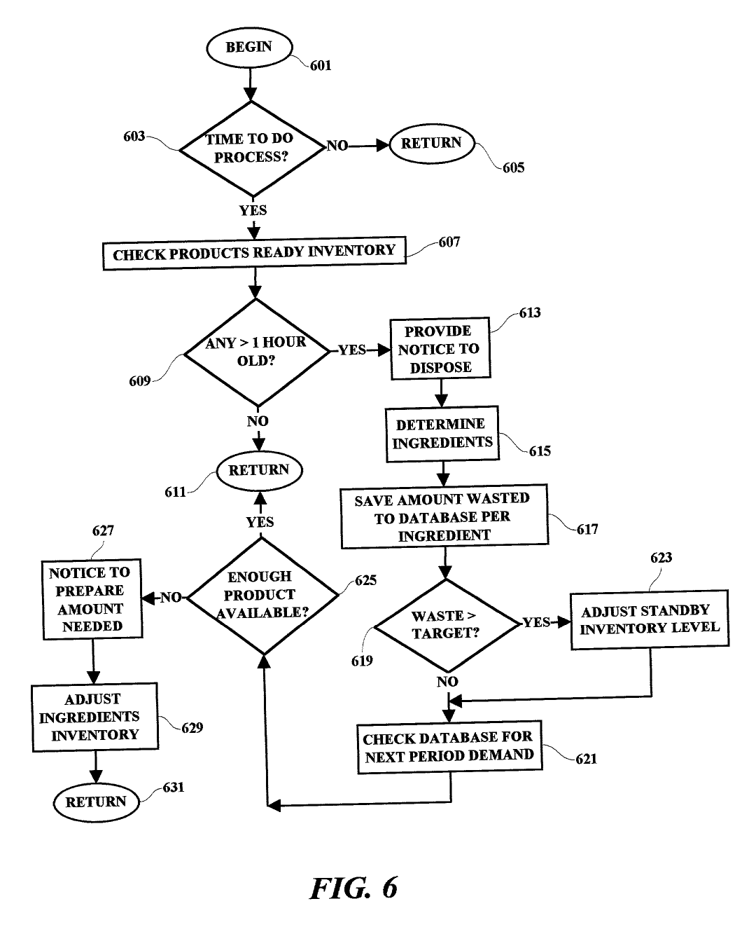

A waste management aspect, inter alia, of the disclosed methodology is illustrated in FIG. 6. As shown, the processing begins 601 by determining, with a clock or calendar check, if it is time to do one of several periodic processing routines. For example, the methodology illustrated in FIG. 6 may be executed on the hour, every hour, in a fast food establishment to check for stale food products and update a waste database which is maintained in server memory. If the check is made and it is not time for a run 603 then the process may be returned to receive new orders 503 at the top of FIG. 5. If it is time to run the hourly periodic waste routine 603, then a check is made of the products ready inventory 607. If none of the products are more than one hour (or any other appropriate time period) old, then the process returns 611 to the ordering routine in FIG. 5. If, however, any of the products were prepared more than 1 hour ago 609 but have not yet been sold, then notice is given to dispose of those products 613. Although 1 hour is used in the example, the exact age at which a product will be disposed of will vary depending upon the nature of product and the particular application. The notice to dispose may be provided in any of several manners such as a flashing display visible to an employee of the restaurant. This may also be done with an automated system in which the warming trays may be released or flapped down such that designated food products that are more than 1 hour old for example, are automatically dumped into a waste bin under the warming tray arrangement in response to the detection of an electronic signal generated as a result of the product age determination 609. It is noted that when the sensors detect that there is a food product in a designated warming tray position, the system will automatically mark the time so that every hour that time mark is accessed in determining the age of the corresponding food product.

The ingredients for the wasted food products are determined 615 and the amount of wasted ingredients is saved 617 to a waste database in the server 101. A running total of the waste is determined and if the amount of waste during any given period, e.g. during any hour, is greater than a target number 619 then the standby inventory level for that ingredient is adjusted 623 so that less of the ingredient will be available and less will be wasted in the future. If the waste is within a predetermined acceptable range 619, then the server demand database is checked for any demand periods expected during the next period 621 i.e. during the next hour. If enough food product is available 625 for any expected demand as determined through reference to the demand database, then the process returns to the ordering routine of FIG. 5. If there is not sufficient product ready for the next hour in view of an increased demand noted in the demand database, then notice is given to prepare the food products needed 627, and the ingredients inventories are adjusted 629 before returning to the ordering routine. It is noted that the programming disclosed herein allows for maintaining a running total in memory for various ingredients and food products and also allows for the physical measurement of the same elements through physical sensing elements. It is contemplated that the electronically maintained database numbers are continuously compared to the physically sensed and measured numbers as a dual reliability check, and that any inconsistencies can be corrected at an early time in the processing cycles thereby avoiding unexpected product or ingredient shortages or stale food products.

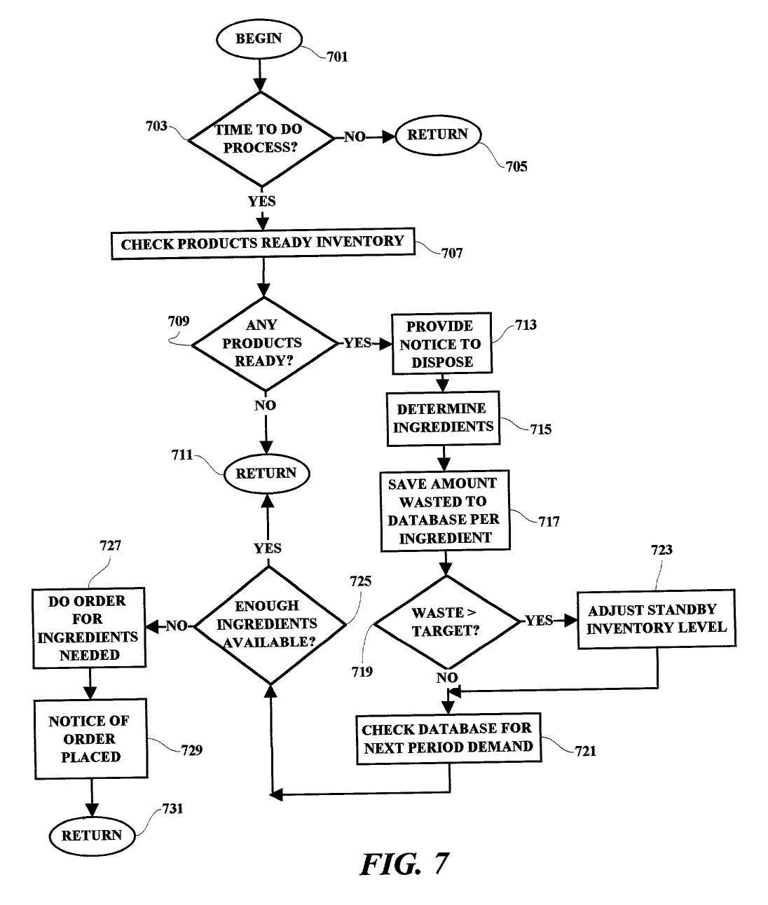

In FIG. 7, there is shown another periodic check which may be run, for example, at the end of every day in combination with other end-of-day programs. As the processing begins 701, a check is made to determine if it is time to do the end-of-day run 703. This could also be an “end-of-morning” run for businesses which prepare only breakfasts, or have different breakfast, lunch and dinner products. If it is not time to do the end-of-period routine 703, the process returns to the order routine of FIG. 5. If, however, it is time, for example, for the end-of-day run 703, then if any ready (i.e. cooked but not sold) food products are still available, then appropriate notice to dispose is given 713, the ingredients for the disposed products are determined 715 and saved to the waste database 717. A check is then made to determine if the waste is within an acceptable limit 719. If not, the standby level for the overly wasted ingredient is adjusted 723 and the demand database is checked for the next demand period 721, which in this case is the next day. If enough ingredients are available 725 then the process returns to the order taking routine for the next day. If there are insufficient ingredients available to make sufficient food products for the expected demand for the next day 725, then additional ingredients are automatically ordered 727 (e.g. by email) and notice that the order has been placed is given in a predetermined manner such as an email to the restaurant manager. Notice will allow the manager to track orders and follow-up with the supplier if necessary. The process will then return to be prepared to receive the next customer order.

The method and apparatus of the present invention has been described in connection with a preferred embodiment as disclosed herein. The disclosed methodology may be implemented in a wide range of sequences, menus and screen designs to accomplish the desired results as herein illustrated. Although an embodiment of the present invention has been shown and described in detail herein, along with certain variants thereof, many other varied embodiments that incorporate the teachings of the invention may be easily constructed by those skilled in the art, and even included or integrated into a processor or CPU or other larger system integrated circuit or chip. The disclosed methodology may also be implemented solely in program code and executed to achieve the beneficial results as described herein. Accordingly, the present invention is not intended to be limited to the specific form set forth herein, but on the contrary, it is intended to cover such alternatives, modifications, and equivalents, as can be reasonably included within the spirit and scope of the invention.

What is claimed is:

1. A method for processing information related to sales of a food product, said food product including a number of ingredients, said method comprising:
determining a number of said food products which have been scheduled to be prepared for sale during a predetermined period of time; and
accessing a database to determine a reference number of food products which have been sold during a corresponding past period of time.

2. The method as set forth in claim 1 and further including:
adjusting said number of food products scheduled for preparation in accordance with said referenced number.

3. The method as set forth in claim 2 wherein said database further includes information related to a stated reason for said reference number.

4. The method as set forth in claim 3 wherein said information related to said stated reason for said reference number is presented on a display device.

5. The method as set forth in claim 1 wherein food products which have been prepared for sale are placed in predetermined holding locations pending an order for a sale, the number of said food products which are available for sale being determined by product detecting means.

6. The method as set forth in claim 5 wherein said product detecting means is a light sensing device.

7. The method as set forth in claim 5 wherein said product detecting means is a weight sensing device.

8. The method as set forth in claim 1 and further including:
maintaining a record of current inventory levels of said ingredients.

9. The method as set forth in claim 8 and further including determining an occurrence of a sale of one of said food products; and
adjusting an inventory level of one or more ingredients comprising said food product in response to said sale.

10. The method as set forth in claim 9 and further including providing notice of low inventory levels when said inventory levels fall below a predetermined reference level.

11. The method as set forth in claim 9 and further including automatically ordering amounts of said one or more ingredients when said inventory levels for said one or more ingredients falls below said reference levels.

12. The method as set forth in claim 11 wherein said ordering is accomplished by sending an electronically generated message to a supplier of said one or more ingredients.

13. The method as set forth in claim 12 wherein said electronically generated message is an email sent from a restaurant server system to a supplier server system.

14. A method for processing information related to a food product preparation operation wherein food products are prepared from ingredients and offered for sale, said food products being maintained in a prepared state pending a sale of said food products, said method comprising:
marking a preparation time when a food product has been prepared;
detecting a continuing presence of said food product in said prepared state; and
after a selected time period, disposing of any of said prepared food products which have not been sold for more than a predetermined period of time since being prepared.

15. The method as set forth in claim 14 and further including adjusting an amount of prepared food products available for sale if said amount of disposed of food products exceeds a predetermined acceptable amount.

16. The method as set forth in claim 15 and further including recording said amount of disposed of food products as waste information in a database whereby said amount of prepared food products is adjusted in accordance with said recorded waste information in said database.

17. The method as set forth in claim 14 and further including:
determining amounts of wasted ingredients for said disposed of food products;
recording said amount of said wasted ingredients in a database; and
adjusting amounts of ingredients on hand for the preparation of said food products in accordance with said amounts of said wasted ingredients.

18. A storage medium including machine readable coded indicia, said storage medium being selectively coupled to a reading device, said reading device being selectively coupled to processing circuitry within a computer system, said reading device being selectively operable to read said machine readable coded indicia and provide program signals representative thereof, said program signals being effective to enable a processing of information related to sales of a food product, said food product including a number of ingredients, said program signals being further effective for:
determining a number of said food products which have been scheduled to be prepared for sale during a predetermined period of time; and
accessing a database to determine a reference number of food products which have been sold during a corresponding past period of time.

19. The medium as set forth in claim 18 wherein said program signals are further effective for:
adjusting said number of food products scheduled for preparation in accordance with said referenced number.

20. The medium as set forth in claim 19 wherein said database further includes information related to a stated reason for said reference number.

21. The medium as set forth in claim 20 wherein said information related to said stated reason for said reference number is presented on a display device.

22. The medium as set forth in claim 18 wherein food products which have been prepared for sale are placed in predetermined holding locations pending an order for a sale, the number of said food products which are available for sale being determined by product detecting means.

23. The medium as set forth in claim 22 wherein said product detecting means is a light sensing device.

24. The medium as set forth in claim 22 wherein said product detecting means is a weight sensing device.

25. The medium as set forth in claim 18 wherein said program signals are further effective for:
maintaining a record of current inventory levels of said ingredients.

26. The medium as set forth in claim 25 wherein said program signals are further operable for:
effecting a determination of an occurrence of a sale of one of said food products; and
adjusting an inventory level of one or more ingredients comprising said food product in response to said sale.

27. The medium as set forth in claim 26 wherein said program signals are further effective for providing notice of low inventory levels when said inventory levels fall below a predetermined reference level.

28. The medium as set forth in claim 26 wherein said program signals are further effective for automatically ordering amounts of said one or more ingredients when said inventory levels for said one or more ingredients falls below said reference levels.

29. The medium as set forth in claim 28 wherein said ordering is accomplished by sending an electronically generated message to a supplier of said one or more ingredients.

30. The medium as set forth in claim 29 wherein said electronically generated message is an email sent from a restaurant server system to a supplier server system.

31. A storage medium including machine readable coded indicia, said storage medium being selectively coupled to a reading device, said reading device being selectively coupled to processing circuitry within a computer system, said reading device being selectively operable to read said machine readable coded indicia and provide program signals representative thereof, said program signals being effective to enable a processing of information related to a food product preparation operation wherein food products are prepared from ingredients and offered for sale, said food products being maintained in a prepared state pending a sale of said food products, said program signals being further effective for:
effecting a marking of a preparation time when a food product has been prepared;
causing a detecting of a continuing presence of said food product in said prepared state; and
after a selected time period, effecting a disposing of any of said prepared food products which have not been sold for more than a predetermined period of time since being prepared.

32. The medium as set forth in claim 31 wherein said program signals are further effective for adjusting an amount of prepared food products available for sale if said amount of disposed of food products exceeds a predetermined acceptable amount.

33. The medium as set forth in claim 31 wherein said program signals are further effective for:
determining amounts of wasted ingredients for said disposed of food products;
storing said amount of said wasted ingredients in a database; and
adjusting amounts of ingredients on hand for preparation of said food products in accordance with said amounts of said wasted ingredients.

34. A computer system comprising:
a system bus;
a CPU device connected to said system bus;
a memory device connected to said system bus;
a user display device connected to said system bus; and
connection means arranged to connect said computer system to a network, said computer system being selectively operable for implementing a method for processing information related to sales of a food product, said food product including a number of ingredients, said method comprising:
determining a number of said food products which have been scheduled to be prepared for sale during a predetermined period of time; and
accessing a database in said computer system to determine a reference number of food products which have been sold during a corresponding past period of time.

35. The computer system as set forth in claim 34 and further including means for adjusting said number of food products scheduled for preparation in accordance with said referenced number.

36. The computer system as set forth in claim 35 wherein said database further includes information related to a stated reason for said reference number.

37. The computer system as set forth in claim 36 wherein said information related to said stated reason for said reference number is presented on said display device.

38. A computer system for processing information related to a food product preparation operation wherein food products are prepared from ingredients and offered for sale, said food products being maintained in a prepared state pending a sale of said food products, said computer system comprising:
a system bus;
a CPU device connected to said system bus;
a memory device connected to said system bus;
a user display device connected to said system bus; and
connection means arranged to connect said computer system to a network, said computer system being selectively operable for marking a preparation time when a food product has been prepared, and detecting a continuing presence of said food product in said prepared state, said computer system being further operable for periodically disposing of any of said prepared food products which have not been sold for more than a predetermined period of time since being prepared.

39. The computer system as set forth in claim 38 and further including means for adjusting an amount of prepared food products available for sale if said amount of disposed of food products exceeds a predetermined acceptable amount.

40. The computer system as set forth in claim 39 and further including means for determining amounts of wasted ingredients for said disposed of food products and means for adjusting amounts of ingredients on hand for the preparation of said food products in accordance with said amounts of said wasted ingredients.
